(19) United States
(12) Patent Application Publication
(10) Pub. No.: US 2014/0089604 A1
(43) Pub. Date: Mar. 27, 2014

(54) BIPOLAR COLLAPSIBLE FIFO

(71) Applicant: APPLE INC., Cupertino, CA (US)

(72) Inventors: Peter F. Holland, Los Gatos, CA (US); Albert C. Kuo, Mountain View, CA (US); Joseph P. Bratt, San Jose, CA (US)

(73) Assignee: APPLE INC., Cupertino, CA (US)

(21) Appl. No.: 13/629,100

(22) Filed: Sep. 27, 2012

(51) Int. Cl. G06F 12/00

(52) U.S. Cl. 711/147; 711/E12.001

(57) ABSTRACT

A system and method for efficient dynamic utilization of shared resources. A computing system includes a shared buffer accessed by two requestors generating access requests. Any entry within the shared buffer may be allocated for use by a first requestor or a second requestor. The storage buffer stores received indications of access requests from the first requestor beginning at a first end of the storage buffer. The storage buffer stores received indications of access requests from the second requestor beginning at a second end of the storage buffer. The storage buffer maintains an oldest stored indication of an access request for the first requestor at the first end and an oldest stored indication of an access request for the second requestor at the second end. The shared buffer deallocates in-order of age from oldest to youngest allocated entries corresponding to a given requestor of the first requestor and the second requestor.

### BACKGROUND OF THE INVENTION

1. Field of the Invention

This invention relates to semiconductor chips, and more particularly, to efficient dynamic utilization of shared storage resources.

2. Description of the Relevant Art

A semiconductor chip may include multiple functional blocks or units, each capable of generating access requests for a shared resource. In some embodiments, the multiple functional units are individual dies on an integrated circuit (IC), such as a system-on-a-chip (SOC). In other examples, the multiple functional units are individual dies within a package, such as a multi-chip module (MCM). In yet other examples, the multiple functional units are individual dies or chips on a printed circuit board. The shared resource may be a shared memory, a complex arithmetic unit, and so forth.

The multiple functional units on the chip are requestors that generate access requests. In various examples, the access requests are memory access requests for a shared memory. Additionally, one or more functional units may include multiple requestors. For example, a display subsystem in a computing system may include multiple requestors for graphics frame data. The design of a smartphone or computer tablet may include user interface layers, cameras, and video sources such as media players. A given display pipeline may include multiple internal pixel-processing pipelines. The generated access requests or indications of the access requests may be stored in one or more resources.

When multiple requestors are active, assigning the requestors to separate copies or versions of a resource may reduce the design and the communication latencies. For example, a storage buffer or queue includes multiple entries, each entry used to store an access request or an indication of an access request. Each active requestor may have a separate associated storage buffer. Additionally, multiple active requestors may utilize a single storage buffer. The single storage buffer may be partitioned with each active requestor assigned to a separate partition within the storage buffer. Regardless of the use of a single, partitioned storage buffer or multiple assigned storage buffers, when a given active requestor consumes its assigned entries, this static partitioning causes the given active requestor to wait until a portion of its assigned entries are deallocated and available once again. The benefit of the available parallelization is reduced. Additionally, while the given active requestor is waiting, entries assigned to other active requestors may be unused. Accordingly, the static partitioning underutilizes the storage buffer(s).

In view of the above, methods and mechanisms for efficiently processing requests to a shared resource are desired.

### SUMMARY OF EMBODIMENTS

Systems and methods for efficient dynamic utilization of shared resources are contemplated. In various embodiments, a computing system includes a shared resource accessed by two requestors. In some embodiments, the shared resource is a shared buffer. The requestors may be functional units that generate access requests, such as access requests for data stored in a shared memory. Either the generated access requests or indications of the access requests may be stored in the shared buffer. Any entry within the shared buffer may be allocated for use by a first requestor or a second requestor.

Control logic within the shared storage buffer may store received indications of access requests from a first requestor beginning at a first end of the storage buffer. The indications may be stored in an in-order contiguous manner. In addition, the control logic may store received indications of access requests from a second requestor beginning at a second end of the storage buffer. The second end is different from the first end. Similar to the first requestor, the indications may be stored in an in-order contiguous manner.

The control logic may maintain an oldest stored indication of an access request for the first requestor at the first end of the shared buffer. Similarly, the control logic may maintain an oldest stored indication of an access request for the second requestor at the second end of the shared buffer. Stored indications of access requests may include at least an identifier (ID) used to identify response data corresponding to the access requests. The control logic within the shared buffer may deallocate entries within the shared buffer in any order. In response to detecting an entry corresponding to the given requestor is deallocated, the control logic may collapse remaining entries to eliminate any gaps left by the deallocated entry. IN various embodiments, such collapsing may include shifting remaining allocated entries of the given requestor toward an end of the storage buffer so that the above mentioned gaps are closed.

These and other embodiments will be further appreciated upon reference to the following description and drawings.

### BRIEF DESCRIPTION OF THE DRAWINGS

FIG. 1 is a generalized block diagram of one embodiment of shared storage allocations.

FIG. 2 is a generalized flow diagram of one embodiment of a method for allocating entries in a bipolar collapsible first-in-first-out (FIFO) buffer.

FIG. 3 is a generalized flow diagram of one embodiment of a method for deallocating entries in a bipolar collapsible first-in-first-out (FIFO) buffer.

FIG. 4 is a generalized block diagram of one embodiment of a display controller.

FIG. 5 is a generalized block diagram of one embodiment of internal pixel-processing pipelines.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six, interpretation for that unit/circuit/component.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention.

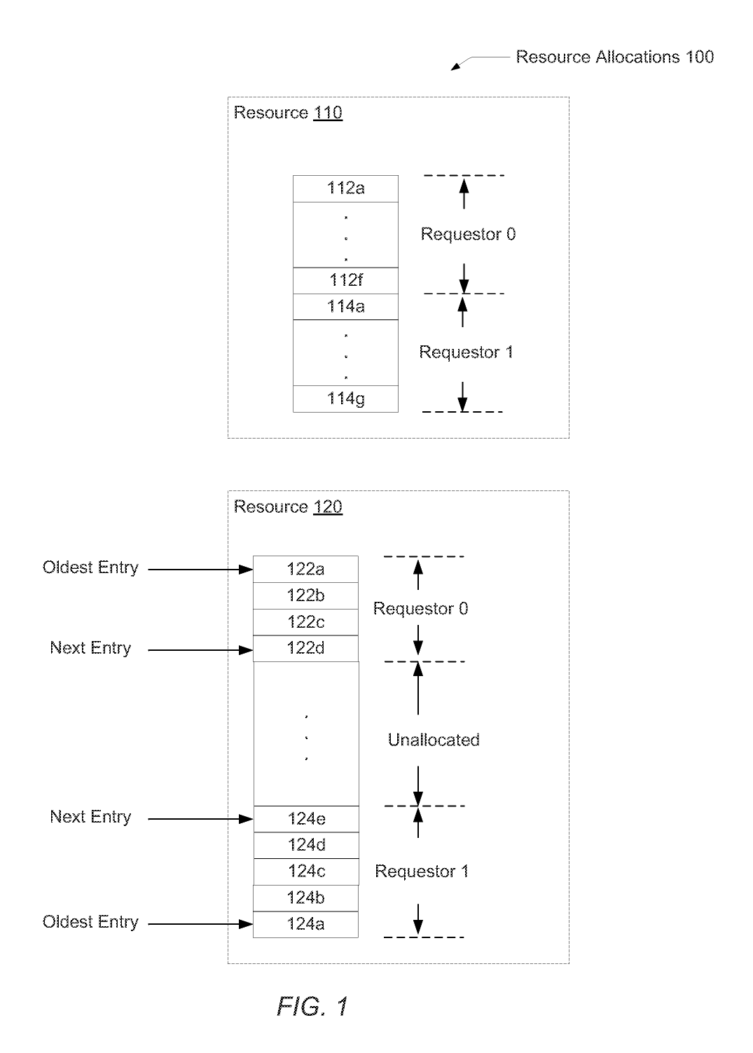

Referring to FIG. 1, one embodiment of resource allocations 100 is shown. In various embodiments, resource 110 corresponds to a buffer or a queue used for data storage. Resource 110 may comprise a plurality of entries including entries 112a-112f and 114a-114g. Resource 110 may be statically partitioned on a requestor basis. For example, a requestor 0 may utilize entries 112a-112f and a requestor 1 may utilize entries 114a-114g. One or more of the entries 112a-112f may be allocated for use in a given clock cycle by the requestor 0. Similarly, one or more of the entries 114a-114g may be allocated for use in a given clock cycle by the requestor 1.

In some embodiments, the entries are allocated and deallocated in dynamic manner, wherein a content addressable memory (CAM) search is performed to locate a given entry storing particular information. Age information may be stored in the entries. In other embodiments, the entries are allocated and deallocated in a first-in-first-out (FIFO) manner. Other methods and mechanisms for allocating and deallocating one or more entries at a time are possible and contemplated. Control logic used for allocation, deallocation, the updating of counters and pointers, and other functions is not shown for ease of illustration.

Each of the entries 112a-112f and 114a-114g may store the same type of information. In some embodiments, the information stored in an allocated entry includes a generated memory access request. In other embodiments, the information stored in an allocated entry includes a generated indication of a memory access request. Stored indications of access requests may include at least an identifier (ID) used to identify response data corresponding to the access requests.

The static partitioning in the resource 110 may avoid starvation and reduce hardware overhead. However, scalability may be difficult. As the number of requestors increases, the consumption of on-chip real estate and power consumption may increase linearly. Also, signal line lengths greatly increase, which, due to cross-capacitance, degrade the signals being conveyed by these lines. Additionally, full resource utilization may not be achieved. If the requestor 0 is inactive and the requestor 1 is active, the entries 112a-112f are not utilized as the requestor 1 only utilizes the entries 114a-114g. The static partitioning does not dynamically react to workloads.

In various embodiments, the resource 120 also may correspond to a buffer or a queue used for data storage. Resource 120 may include a plurality of entries including at least entries 122a-122d and 124a-124e. Unlike the resource 110, the resource 120 does not utilize static partitioning. Each entry within the resource 120 may be allocated for use by the requestor 0 or the requestor 1. For example, if the requestor 0 is inactive and the requestor 1 is active, the entries 122a-122d, 124a-124e, and other entries not shown within the resource 120 may be utilized by the requestor 1. The reverse scenario is also true. If the requestor 1 is inactive and the requestor 0 is active, each of the entries within the resource 120 may be allocated and utilized by the requestor 0. No given quota or limit may be set for the requestors 0 and 1. Similar to the resource 110, the control logic for the resource 120 for allocation, deallocation, the updating of counters and pointers, and other functions is not shown for ease of illustration.

In various embodiments, when each of the requestor 0 and the requestor 1 is active, the entries are allocated for use for the requestor 0 beginning at the top end of the resource 120. Similarly, the entries are allocated for use for the requestor 1 beginning at the bottom end of the resource 120. For the requestor 0, the entries may be allocated for use in an in-order contiguous manner beginning at the top end of the resource 120. One or more entries may be allocated at a given time, but the entries corresponding to newer information are placed farther away from the top end. For example, if the entries store indications of access requests, then the entries corresponding to the requestor 0 are allocated in-order by age from oldest to youngest indication moving from the top end of the resource 120 downward. Therefore, entry 122d is younger than the entry 122c, which is younger than the entry 122b, and so forth. The control logic for the resource 120 maintains the oldest stored indication of an access request for the requestor 0 at the top end of the resource 120, or the entry 122a.

For the requestor 1, the entries may be allocated for use in an in-order contiguous manner beginning at the bottom end of the resource 120. One or more entries may be allocated at a given time, but the entries corresponding to newer information are placed farther away from the bottom end. The entries corresponding to the requestor 1 are allocated in-order by age from oldest to youngest indication moving from the bottom end of the resource 120 upward. Therefore, entry 124e is younger than the entry 124d, which is younger than the entry 124c, and so forth. The control logic for the resource 120 maintains the oldest stored indication of an access request for the requestor 1 at the bottom end of the resource 120, or the entry 124a.

The processing of the access requests corresponding to the indications stored in the resource 120 may occur in-order. Alternatively, the processing of these access requests may occur out-of-order. The stored indications of access requests may include at least an identifier (ID) used to identify response data corresponding to the access requests.

IN various embodiments, entries within the resource 120 may be deallocated in any order. In response to determining an entry corresponding to the requestor 0 has been deallocated, a gap may be opened amongst allocated entries. For example, if entry 122b is deallocated, a gap between entries 122a and 122c is created (an unallocated entry bounded on either side by allocated entries). In response, entries 122c and 122d may be shifted toward entry 122a in order to close the gap. This shifting to close gaps may generally be referred to as “collapsing.” In this manner, all allocated entries will generally be maintained at one end of the resource 120 or the other—with unallocated entries appearing in the middle.

Maintaining the oldest stored indications at the top end and the bottom end of the resource 120 may simplify other logic surrounding the resource 120. No content addressable memory (CAM) or other search is performed to find the oldest stored indications for the requestors 0 and 1. Response data corresponding to valid allocated entries within the resource 120 may be returned out-of-order, but deallocation within the resource 120 is performed in-order by age from oldest to youngest. The oldest stored information at the ends of the resource 120 may be used as barriers to the amount of processing performed in pipeline stages and buffers following the resource 120. The response data may be further processed in-order by age from oldest to youngest access requests after corresponding entries are deallocated within the resource 120.

When the resource 120 is used in the above-described manner as a storage buffer, the resource 120 may operate as a bipolar collapsible FIFO buffer. When the two requestors are both active, the entries within the resource 120 may be dynamically allocated to the requestors based on demand and a level of activity for each of the two requestors.

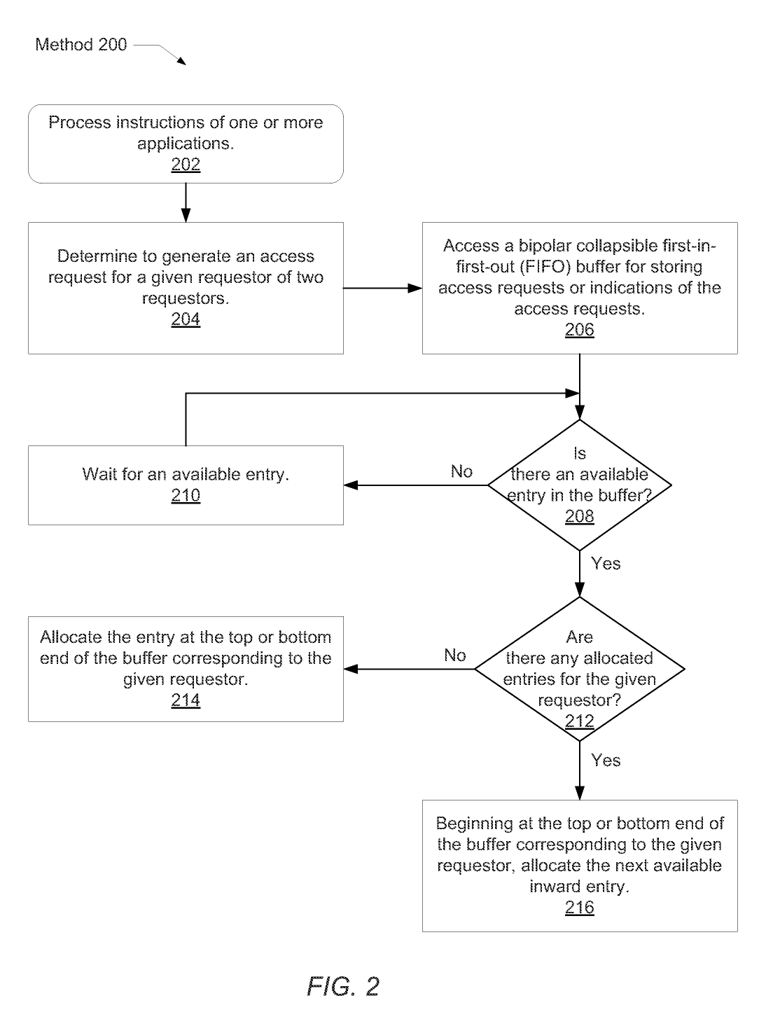

Referring now to FIG. 2, a generalized flow diagram of one embodiment of a method 200 for allocating entries in a bipolar collapsible first-in-first-out (FIFO) buffer is shown. For purposes of discussion, the steps in this embodiment are shown in sequential order. However, in other embodiments some steps may occur in a different order than shown, some steps may be performed concurrently, some steps may be combined with other steps, and some steps may be absent.

In block 202, instructions of one or more software applications are processed by a computing system. In some embodiments, the computing system is an embedded system, such as a system-on-a-chip. The system may include multiple functional units that act as requestors for a shared storage buffer. The requestors may generate access requests to send to a shared resource, such as a shared memory. The access requests or indications of the access requests may be stored in the shared storage buffer.

In block 204, it may be determined a given requestor of two requestors generates an access request. In some embodiments, the access request is a memory read request. For example, an internal pixel-processing pipeline may be ready to read graphics frame data. In other embodiments, the access request is a memory write request. For example, an internal pixel-processing pipeline may be ready to send rendered graphics data to memory for further encoding and processing prior to being sent to an external display. Other examples of access requests are possible and contemplated. Further, the access requests may not be generated yet. Rather, an indication of the access request may be generated and stored. At a later time when particular qualifying conditions are satisfied, the actual access request corresponding to the indication may be generated.

In block 206, a bipolar collapsible first-in-first-out (FIFO) buffer may be accessed for storing access requests or for storing indications of the access requests. The buffer may have two requestors assigned to it. If there is not an available entry in the buffer for the given requestor (conditional block 208), then in block 210, the system may wait for an available entry. No further access requests or indications of access requests may be generated during this time. The buffer may be full. Each unallocated entry in the buffer may be available for allocation for each of the two requestors.

If there is an available entry in the buffer for the given requestor (conditional block 208), and there are no allocated entries for the given requestor (conditional block 212), then in block 214, control logic within the buffer may allocate the entry at the top or the bottom end of the buffer corresponding to the given requestor. This allocated entry corresponds to the oldest stored information of an access request for the given requestor. Referring again to FIG. 1, the allocated entry corresponds to either entry 122a or entry 124a of the resource 120 depending on the given requestor.

Returning to the method 200 in FIG. 2, if there are allocated entries for the given requestor (conditional block 212), then in block 216, control logic within the buffer may begin at the top or the bottom end of the buffer corresponding to the given requestor and allocate the next available inward entry. For example, if the given requestor corresponds to the top of the buffer, then referring again to FIG. 1, entries 122a and 122b of the resource 120 may be allocated. The next available entry moving inward is the entry 122c, if the other requestor has not already allocated it.

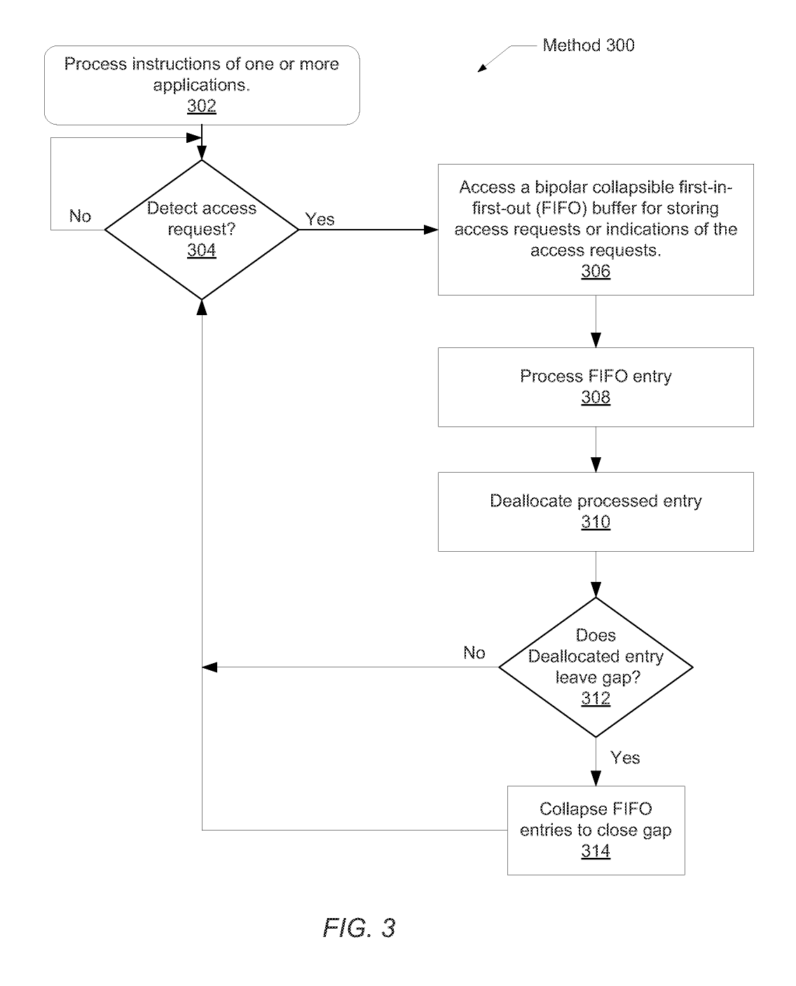

Referring now to FIG. 3, a generalized flow diagram of one embodiment of a method 300 for deallocating entries in a bipolar collapsible first-in-first-out (FIFO) buffer is shown. For purposes of discussion, the steps in this embodiment are shown in sequential order. However, in other embodiments some steps may occur in a different order than shown, some steps may be performed concurrently, some steps may be combined with other steps, and some steps may be absent.

In block 302, instructions of one or more software applications are processed by a computing system. The system may include multiple functional units that act as requestors for a shared storage buffer. The requestors may generate access requests to send to a shared resource, such as a shared memory. The access requests or indications of the access requests may be stored in the shared storage buffer.

In block 304, an access request for a given requestor of two requestors may be detected. In some embodiments, the access request is a memory read request. The memory read request may be determined to be processed when corresponding response data has been returned for the request. The response data may be written into the same buffer storing the read request or an indication of the read request. Alternatively, the response data may be written into another queue and an indication is sent to the buffer in order to mark a corresponding entry that the read request is processed. In other embodiments, the access request is a memory write request. The memory write request may be determined to be processed when a corresponding write acknowledgment control signal is received. The acknowledgment signal may indicate that the write data has been written into a corresponding destination.

In block 306, a bipolar collapsible first-in-first-out (FIFO) buffer for storing access requests or indications of the access requests may be accessed. It is noted that while a give resource may be referred to herein as a FIFO, it is to be understood that in various embodiments a strict first-in-first-out ordering is not required. For example, in various embodiments, entries within the FIFO may be processed and/or deallocated in any order—irrespective of an order in which they were placed in the FIFO. In the example shown, the buffer may have two requestors assigned to it. As noted above, entries within the FIFO may be processed and deallocated in any order. Responsive to the request, the targeted FIFO entry is processed (block 308) and the entry deallocated (block 310). If deallocation of the entry leaves a gap amongst allocated entries (decision block 312), then the remaining allocated entries for that requestor may collapse (block 314) toward that requestor's end in order to close the gap. If on the other hand the deallocation does not leave a gap (e.g., the youngest entry was deallocated), then no collapse is needed.

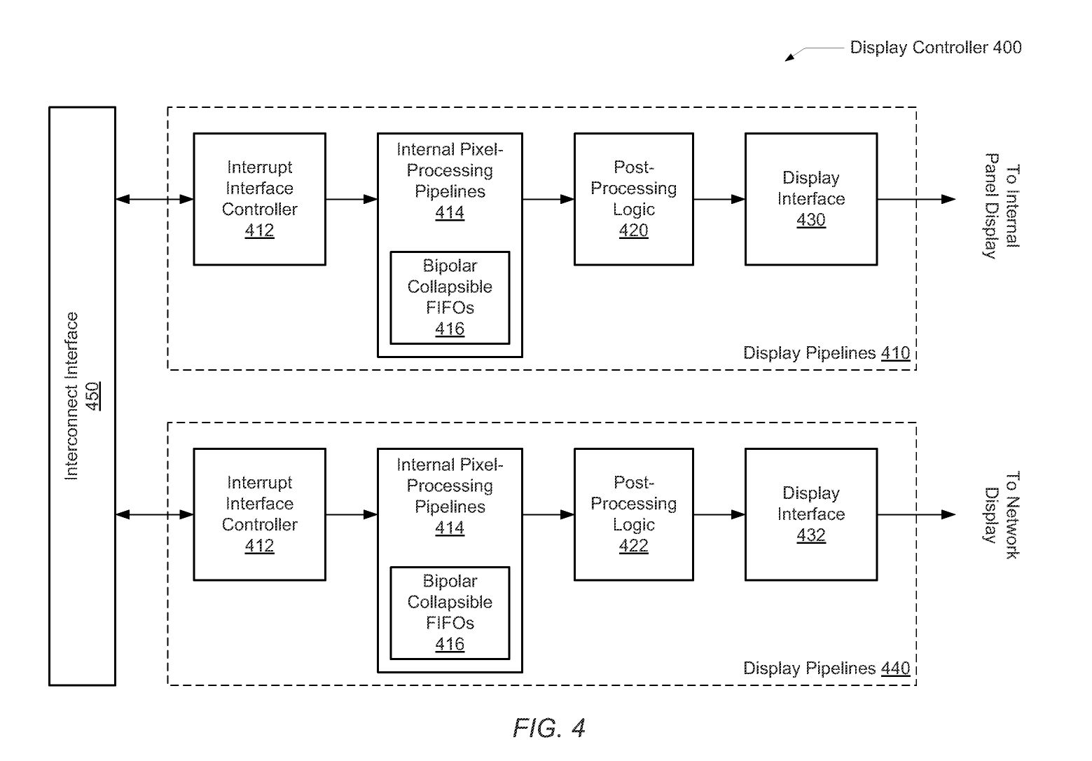

Turning now to FIG. 4, a generalized block diagram of one embodiment of a display controller 400 is shown. The display controller 400 is one example of a component that includes one or more bipolar collapsible FIFOs. The display controller 400 may use the bipolar collapsible FIFOs for storing memory access requests and/or indications of memory access requests. The display controller 400 sends graphics output information that was rendered to one or more display devices. The graphics output information may correspond to frame buffers accessed via a memory mapping to the memory space of a graphics processing unit (GPU). The frame data may be for an image to be presented on a display. The frame data may include at least color values for each pixel on the screen. The frame data may be read from the frame buffers stored in off-die synchronous dynamic random access memory (SDRAM) or in on-die caches.

The display controller 400 may include one or more display pipelines, such as pipelines 410 and 440. Each display pipeline may send rendered graphical information to a separate display. For example, the pipeline 410 may be connected to an internal panel display and the pipeline 440 may be connected to an external network-connected display. Other examples of display screens may also be possible and contemplated. Each of the display pipelines 410 and 440 may include one or more internal pixel-processing pipelines. The internal pixel-processing pipelines may act as requestors for one or more bipolar collapsible FIFOs.

The interconnect interface 450 may include multiplexers and control logic for routing signals and packets between the display pipelines 410 and 440 and a top-level fabric. Each of the display pipelines may include an interrupt interface controller 412. The interrupt interface controller 412 may provide encoding schemes, registers for storing interrupt vector addresses, and control logic for checking, enabling, and acknowledging interrupts. The number of interrupts and a selected protocol may be configurable. In some embodiments, the controller 412 uses the AMBA® AXI (Advanced eXtensible Interface) specification.

Each display pipeline within the display controller 562 may include one or more internal pixel-processing pipelines 414. The internal pixel-processing pipelines 414 may include one or more ARGB (Alpha, Red, Green, Blue) pipelines for processing and displaying user interface (UI) layers. In various embodiments a layer may refer to a presentation layer. A presentation layer may consist of multiple software components used to define one or more images to present to a user. The UI layer may include components for at least managing visual layouts and styles and organizing browses, searches, and displayed data. The presentation layer may interact with process components for orchestrating user interactions and also with the business or application layer and the data access layer to form an overall solution. However, the internal pixel-processing pipelines 414 handle the UI layer portion of the solution.

The internal pixel-processing pipelines 414 may include one or more pipelines for processing and displaying video content such as YUV content. In some embodiments, each of the internal pixel-processing pipelines 414 include blending circuitry for blending graphical information before sending the information as output to respective displays.

Each of the internal pixel-processing pipelines within the one or more display pipelines may independently and simultaneously access respective frame buffers stored in memory. The multiple internal pixel-processing pipelines may act as requestors to one or more bipolar collapsible FIFOs 416. Although each of the FIFOs 416 is shown in the block 414, the other blocks within the display controller 400 may also include bipolar collapsible FIFOs.

The post-processing logic 420 may be used for color management, ambient-adaptive pixel (AAP) modification, dynamic backlight control (DPB), panel gamma correction, and dither. The display interface 430 may handle the protocol for communicating with the internal panel display. For example, the Mobile Industry Processor Interface (MIPI) Display Serial Interface (DSI) specification may be used. Alternatively, a 4-lane Embedded Display Port (eDP) specification may be used.

The display pipeline 440 may include post-processing logic 422. The post-processing logic 422 may be used for supporting scaling using a 5-tap vertical, 9-tap horizontal, 16-phase filter. The post-processing logic 422 may also support chroma subsampling, dithering, and write back into memory using the ARGB888 (Alpha, Red, Green, Blue) format or the YUV420 format. The display interface 432 may handle the protocol for communicating with the network-connected display. A direct memory access (DMA) interface may be used.

The YUV content is a type of video signal that consists of three separate signals. One signal is for luminance or brightness. Two other signals are for chrominance or colors. The YUV content may replace the traditional composite video signal. The MPEG-2 encoding system in the DVD format uses YUV content. The internal pixel-processing pipelines 414 handle the rendering of the YUV content.

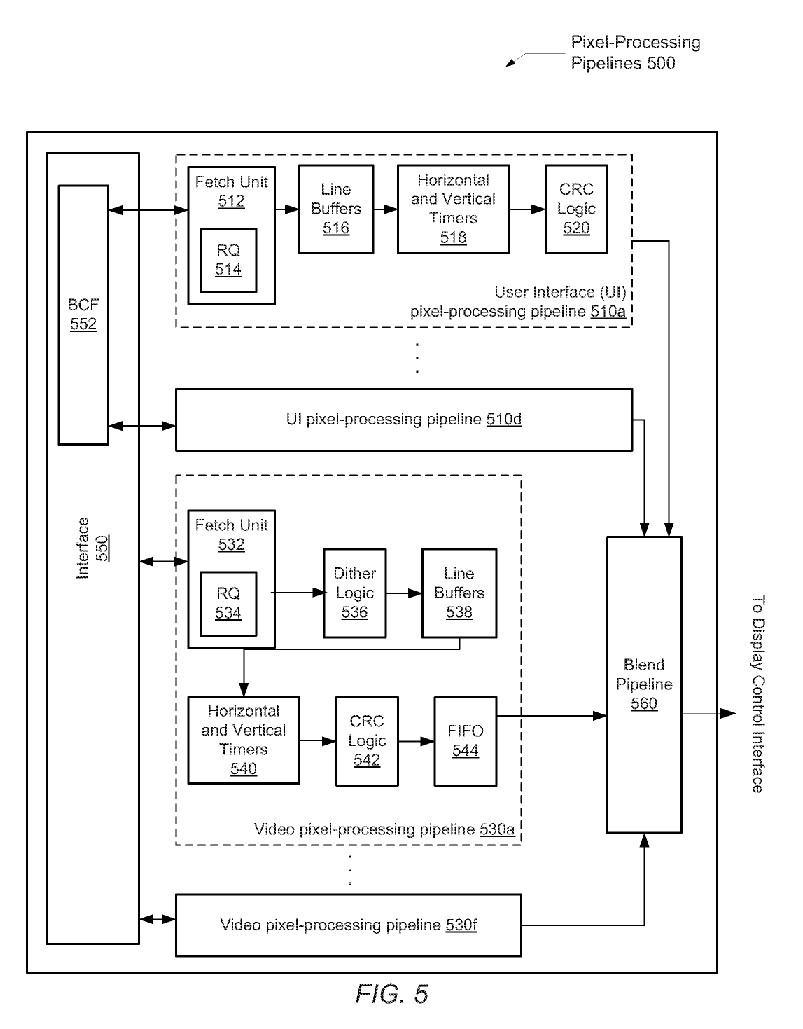

Turning now to FIG. 5, a generalized block diagram of one embodiment of the pixel-processing pipelines 500 within the display pipelines is shown. Each of the display pipelines within a display controller may include the pixel-processing pipelines 500. The pipelines 500 may include user interface (UI) pixel-processing pipelines 510a-510d and video pixel-processing pipelines 530a-530f.

The interconnect interface 550 may act as a master and a slave interface to other blocks within an associated display pipeline. Read requests may be sent out and incoming response data may be received. The outputs of the pipelines 510a-510d and the pipelines 530a-530f are sent to the blend pipeline 560. The blend pipeline 560 may blend the output of a given pixel-processing pipeline with the outputs of other active pixel-processing pipelines. In one embodiment, interface 550 may include one or more bipolar collapsible FIFOs (BCF) 552. For example, BCF 552 in FIG. 5 is shown to be shared by pipeline 510a and pipeline 510d. IN other embodiments, BCF 552 may be located elsewhere within pipelines 500 in a location that is not within interconnect interface 550. All such locations are contemplated. In some embodiments, the bipolar collapsible FIFOs store memory read requests generated by the assigned internal pixel-processing pipelines. In other embodiments, the bipolar collapsible FIFOs store memory write requests generated by the assigned internal pixel-processing pipelines.

The UI pipelines 510a-510d may be used to present one or more images of a user interface to a user. A fetch unit 512 may send out read requests for frame data and receive responses. The read requests may be generated and stored in a request queue (RQ) 514. Alternatively, the request queue 514 may be located in the interface 550. Corresponding response data may be stored in the line buffers 516.

The line buffers 516 may store the incoming frame data corresponding to row lines of a respective display screen. The horizontal and vertical timers 518 may maintain the pixel pulse counts in the horizontal and vertical dimensions of a corresponding display device. A vertical timer may maintain a line count and provide a current line count to comparators. The vertical timer may also send an indication when an end-of-line (EOL) is reached. The Cyclic Redundancy Check (CRC) logic block 520 may perform a verification step at the end of the pipeline. The verification step may provide a simple mechanism for verifying the correctness of the video output. This step may be used in a test or a verification mode to determine whether a respective display pipeline is operational without having to attach an external display.

Within the video pipelines 530a-530f, the blocks 532, 534, 538, 540, and 542 may provide functionality corresponding to the descriptions for the blocks 512, 514, 516, 518, 520 and 522 within the UI pipelines. The fetch unit 532 fetches video frame data in various YCbCr formats. Similar to the fetch unit 512, the fetch unit 532 may include a request queue (RQ) 534. The dither logic 536 inserts random noise (dither) into the samples. The timers and logic in block 540 scale the data in both vertical and horizontal directions. The FIFO 544 may store rendered data before sending it out. Again, although the bipolar collapsible FIFOs are shown at the input of the pipelines within the interface 550, one or more of the bipolar collapsible FIFOs may be in logic at the end of the pipelines. The methods and mechanisms described earlier may be used to control these FIFOs within the pixel-processing pipelines.

In various embodiments, program instructions of a software application may be used to implement the methods and/or mechanisms previously described. The program instructions may describe the behavior of hardware in a high-level programming language, such as C. Alternatively, a hardware design language (HDL) may be used, such as Verilog. The program instructions may be stored on a computer readable storage medium. Numerous types of storage media are available. The storage medium may be accessible by a computer during use to provide the program instructions and accompanying data to the computer for program execution. In some embodiments, a synthesis tool reads the program instructions in order to produce a netlist comprising a list of gates from a synthesis library.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
a first requestor configured to generate access requests for data;
a second requestor configured to generate access requests for data; and
a shared storage resource comprising a plurality of entries; and
wherein the shared storage resource is configured to:
store indications of access requests from the first requestor in an in-order contiguous manner beginning at a first end of the storage resource; and
store indications of access requests from the second requestor in an in-order contiguous manner beginning at a second end of the storage resource, wherein the second end is different from the first end.

2. The apparatus as recited in claim 1, wherein the apparatus is configured to maintain an oldest stored indication of an access request for the first requestor at the first end and an oldest stored indication of an access request for the second requestor at the second end.

3. The apparatus as recited in claim 2, wherein any entry of the plurality of entries may be allocated for use by the first requestor or the second requestor.

4. The apparatus as recited in claim 3, wherein allocated entries corresponding to a given requestor of the first requestor and the second requestor may be deallocated in any order.

5. The apparatus as recited in claim 4, wherein when an entry corresponding to the given requestor is deallocated, remaining stored indications of the given requestor are shifted toward an end of the shared resource such that a gap created by the deallocated entry is closed.

6. The apparatus as recited in claim 4, wherein stored indications in the shared resource may be processed out-of-order with respect to age.

7. The apparatus as recited in claim 6, wherein the stored indications of access requests comprise at least an identifier (ID) used to identify response data corresponding to the access requests.

8. The apparatus as recited in claim 6, wherein the first requestor corresponds to a first pixel-processing pipeline, the second requestor corresponds to a second pixel-processing pipeline, and the data corresponds to frame data.

9. The apparatus as recited in claim 8, wherein the apparatus is a system-on-a-chip (SOC).

10. A method comprising:
generating access requests for a first requestor;
generating access requests for a second requestor;
storing indications of access requests from the first requestor in an in-order contiguous manner beginning at a first end of a shared storage resource; and
storing indications of access requests from the second requestor in an in-order contiguous manner beginning at a second end of the storage resource, wherein the second end is different from the first end.

11. The method as recited in claim 10, further comprising maintaining an oldest stored indication of an access request for the first requestor at the first end and an oldest stored indication of an access request for the second requestor at the second end.

12. The method as recited in claim 11, wherein any entry of the plurality of entries may be allocated for use by the first requestor or the second requestor.

13. The method as recited in claim 12, further comprising deallocating entries corresponding to a given requestor of the first requestor and the second requestor in any order.

14. The method as recited in claim 13, wherein in response to detecting an entry corresponding to the given requestor is deallocated, the method further comprises shifting remaining stored indications of the given requestor toward an end of the shared resource such that a gap created by the deallocated entry is closed.

15. The method as recited in claim 13, processing out-of-order with respect to age the stored indications in the shared resource.

16. The method as recited in claim 15, wherein the stored indications of access requests comprise at least an identifier (ID) used to identify response data corresponding to the access requests.

17. A shared storage buffer comprising:
a plurality of entries for storing indications of access requests;
an interface configured to receive both indications of access requests from a first requestor and a second requestor and response acknowledgments corresponding to stored indications of access requests that have been processed;
control logic configured to:
store received indications of access requests from the first requestor in an in-order contiguous manner beginning at a first end of the storage buffer; and
store received indications of access requests from a second requestor in an in-order contiguous manner beginning at a second end of the storage buffer, wherein the second end is different from the first end.

18. The storage buffer as recited in claim 17, wherein the control logic is further configured to maintain an oldest stored indication of an access request for the first requestor at the first end and an oldest stored indication of an access request for the second requestor at the second end.

19. The storage buffer as recited in claim 18, wherein any entry of the plurality of entries may be allocated for use by the first requestor or the second requestor.

20. The storage buffer as recited in claim 19, wherein the control logic is further configured to deallocate allocated entries corresponding to a given requestor of the first requestor and the second requestor in any order.

21. The storage buffer as recited in claim 20, wherein in response to detecting an entry corresponding to the given requestor is deallocated, the control logic is further configured to shift remaining stored indications of the given requestor such that a gap created by the deallocated entry is closed.

22. The storage buffer as recited in claim 21, wherein indications of access requests stored in the plurality of entries comprise at least an identifier (ID) used to identify response data corresponding to the access requests.

23. A non-transitory computer readable storage medium comprising program instructions operable to efficiently utilize a shared buffer dynamically in a computing system, wherein the program instructions are executable to:
receive both indications of access requests from a first requestor and a second requestor and response acknowledgments corresponding to indications of access requests stored within the shared buffer that have been processed;
store received indications of access requests from the first requestor in an in-order contiguous manner beginning at a first end of the shared buffer; and
store received indications of access requests from a second requestor in an in-order contiguous manner beginning at a second end of the shared buffer, wherein the second end is different from the first end.

24. The storage medium as recited in claim 23, wherein the program instructions are further executable to maintain an oldest stored indication of an access request for the first requestor at the first end and an oldest stored indication of an access request for the second requestor at the second end.

25. The storage medium as recited in claim 24, wherein the program instructions are further executable to deallocate in-order of age from oldest to youngest allocated entries corresponding to a given requestor of the first requestor and the second requestor.
